(19) United States
(12) Patent Application Publication
(10) Pub. No.: US 2024/0400455 A1
(43) Pub. Date: Dec. 5, 2024

(54) CEMENT BOARD

(71) Applicant: SAINT-GOBAIN PLACO, COURBEVOIE (FR)

(72) Inventors: Sonia NAIDU, PARIS (FR); Luc NICOLEAU, VILLEVAUDE (FR)

(21) Appl. No.: 18/695,631

(22) PCT Filed: Sep. 22, 2022
(86) PCT No.: PCT/EP2022/076401

§ 371 Date: Mar. 26, 2024

(30) Foreign Application Priority Data
Sep. 28, 2021 (FR) FR2110202

(51) Int. Cl. C04B 28/14; B28B 19/00; B32B 13/02; B32B 13/04; C04B 14/06; C04B 14/12; C04B 14/18; C04B 14/28; C04B 14/42; C04B 111/00; C04B 111/40

(52) U.S. Cl. CPC C04B 28/14; B32B 13/02; B32B 13/04; C04B 14/06; C04B 14/12; C04B 14/185; C04B 14/28; C04B 14/42; B28B 19/0092; B32B 2262/101; B32B 2607/00; C04B 2111/00629; C04B 2111/40

(57) ABSTRACT

A cement board includes a lightweight core between a first covering layer and a second covering layer, wherein the lightweight core results from the curing of an aqueous cementitious composition including, based on the total dry matter, 20 to 90 wt % of a reactive binder mixture and 10 to 80 wt % of fillers, wherein the reactive binder mixture includes, based on the total dry matter of the reactive binder mixture: 15 to 25 wt % hydraulic cement, 50 to 65 wt % calcium sulphate hemihydrate, and 10 to 35 wt % pozzolanic material; and at least one of the first and second covering layers includes a glass fibre-based sheeting, the sheeting being fully or partially embedded in a cementitious matrix.

The present invention relates to cement boards and process for manufacturing the same.

Conventional processes for producing cement boards on an industrial scale include preparing a cementitious slurry, pouring the cementitious slurry into appropriate moulds having the desired shape and size, taking the boards out of the moulds once the composition is sufficiently set, and curing the boards. Cement boards can also be produced through a continuous process. During such a continuous process, a cementitious slurry is prepared in continuous mixers, the slurry is continuously spread on a lower sheeting carried by a conveyor to an extruder to be shaped into a ribbon. The ribbon is then carried to a cutting station to be cut into boards of desired dimensions before being cured. The two processes have each very different requirements, for instance in terms of viscosity of the slurry and setting time. In particular, for the continuous process, the slurry should set quickly, within a few minutes, during the transit time between the shaping station and the cutting station.

It is known that plaster (calcium sulphate hemihydrate) may be combined with cement to decrease the setting time of cementitious compositions. Several attempts have thus been made to provide cement board compositions suitable for continuous processes. Reactions between gypsum (calcium sulphate dihydrate) and cement can however result in the formation of thaumasite, causing expansion of the matrix and deterioration of the boards. The use of pozzolanic materials, such as silica fume, in gypsum-cement compositions is known to prevent the formation of thaumasite. There is however still a need for improved cement boards that can be obtained by continuous processes.

The present invention is thus directed to a cement board comprising a lightweight core between a first covering layer and a second covering layer, wherein the core results from the curing of an aqueous cementitious composition comprising, based on the total dry matter, 20 to 90 wt. % of a reactive binder mixture and 10 to 80 wt. % of fillers, characterized in that said reactive binder mixture comprises, based on the total dry matter of the reactive binder mixture:
15 to 25 wt. % hydraulic cement
50 to 65 wt. % calcium sulphate hemihydrate, and
10 to 35 wt. % pozzolanic material

The expression “cement board” in the present invention refers to construction boards obtained from cementitious compositions. The cement board according to the present invention comprises relatively low contents of hydraulic cement compared to calcium sulphate hemihydrate. Against all expectations, and despite higher calcium sulphate hemihydrate content, the cement boards according to the invention have similar, if not improved, water resistance. Without being bound to any theory, it is believed that the relatively low content of hydraulic cement results in an increased permeability of the board leading to better moisture management.

The addition of calcium sulphate hemihydrate in the aqueous cementitious composition accelerates the setting time of the Portland cement board. The negative impact calcium sulphate hemihydrate can have relative to the stability of the cement board due to humidity is countered by the presence of the pozzolanic material, which prevents the formation of thaumasite crystals. The cement board according to the invention can thus prevent the formation of thaumasite while having a reasonable setting time, and the cement board also exhibits good workability.

The expression “lightweight core” refers to core having weight of 5 kg/m² to 17 kg/m² and/or a specific gravity of 0.4 to 1.36.

Additionally, cement boards manufactured according to the invention can have a reduced carbon footprint due to their composition, and as such can be more sustainable, low-carbon alternatives to existing cement boards.

The reactive binder mixture comprises 15 wt % to 25 wt %, preferably 17 wt % to 20 wt %, hydraulic cement. The hydraulic cement may be any type of cement: CEM I, II, III, IV or V, as defined in EN 197-1:2000. Preferably, the hydraulic cement is Portland cement (CEM I).

The reactive binder mixture comprises 50 wt. % to 65 wt. %, preferably 52 wt. % to 63 wt. % calcium sulphate hemihydrate. Calcium sulphate hemihydrate can refer either to alpha plaster or beta plaster. Alpha plaster has higher apparent density and lower specific surface area compared to beta plaster, which results in lower water demand for equivalent workability.

The reactive binder mixture comprises 10 wt. % to 35 wt. %, preferably 15 wt. % to 30 wt % pozzolanic material. Pozzolanic material can be selected from silica fumes, fly ash, metakaolin or mixtures thereof.

In a preferred embodiment, the reactive binder mixture comprises, based on dry matter:
17 to 20 wt. % hydraulic cement
52 to 63 wt. % calcium sulphate hemihydrate, and
15 to 30 wt. % pozzolanic material.

The content of hydraulic cement, calcium sulphate hemihydrate and pozzolanic material generally sums up to at least 80 wt. %, preferably at least 90 wt. %, more preferably at least 95 wt. %, even more preferably at least 99 wt. % of the total reactive binder mixture based on dry matter. In some embodiments, the reactive binder mixture consists essentially of, or consists of, hydraulic cement, calcium sulphate hemihydrate and pozzolanic material, i.e., the composition does not comprise further components acting as reactive binder.

The weight ratio of the calcium sulphate hemihydrate to pozzolanic material is preferably less than 2.5. This weight ratio ensures that the setting time of the cement board is appropriate for the manufacturing of cement boards, whereas weight ratios above 2.5 could lead to longer setting times.

The weight ratio of the hydraulic cement to pozzolanic material is preferably less than 2. Such an equilibrium balance between hydraulic cement and pozzolanic materials appears to help maintain the mechanical properties and/or water-resistance of the board at low hydraulic cement content. More particularly, this weight ratio helps prevent the formation of thaumasite crystals, thus maintaining a good resistance of the cement boards over time.

The cement board according to the invention results from the curing of an aqueous cementitious composition comprising, based on the total dry matter, 20 to 90 wt %, preferably 25 to 70 wt. %, more preferably 30 to 50 wt/%, of the reactive binder mixture and 10 to 80 wt. %, preferably 30 to 75 wt. %, more preferably 50 to 70 wt. %, of fillers. It has indeed been found that the composition of the reactive binder mixture used for the cement board of the invention could allow reducing the content of said reactive binder mixture in the board while maintaining acceptable mechanical properties. The lower content of cement in the reactive binder mixture further combined with a lower content of reactive binder mixture in the board advantageously contributes to the provision of cement boards having lower CO2 footprint.

Fillers may be selected from aggregates such as sand, calcium carbonate powdered limestone, greywacke, basalt, dolomite, volcanic rock, slate, and/or recycled material from the production of the cement boards, or mixtures thereof, lightweight fillers such as expanded clay, hydrophobic expanded perlite, expanded shale, polystyrene beads, expanded glass beads, or mixtures thereof, and fibres such as glass fibres, synthetic fibres, natural fibres, and mixtures thereof.

According to the invention, such fillers are intended to be effectively inert materials. Such effectively inert materials do not tend to significantly affect the setting characteristics of the reactive binder mixture. In particular, fillers do not create any significant chemical reaction with the reactive binder mixture.

The components of the present cement board can also comprise additives or admixtures, such admixtures being added, for instance, to alter or enhance the properties of the reactive binder mixture and to improve the quality of the cement board. There are several types of admixtures, among which are retarders, accelerators, plasticisers, foaming agents, bonding agents or corrosion inhibitors.

Retarders are components which can significantly delay the setting time of the reactive binder mixture, without affecting its rheology. Retarders can be chosen from citric acid, tartaric acid, gluconates, phosphates, polyacrylates, polymethylacrylates, sugars and protein-based agents. On the contrary, accelerators can speed up the setting time of the reactive binder mixture. Accelerators can be chosen from soluble salts such as potassium sulphate or ammonium sulphate, mineral acids, most organic acids, most chlorides, most nitrates, most sulphates and most bisulphates.

Plasticisers, or superplasticisers, are used to increase the binder content without affecting the workability, or, to increase the fluidity for a same solid content. Plasticisers or superplasticisers used in the invention may be selected from ligno-sulphonates or synthetic naphthalene sulphonates, polycarboxylate ethers or phosphonated polyarylethers.

Other additives may include foaming agents, which are used to produce air bubbles in the cement board of the invention. Foaming agents can be made from hydrolysed proteins, synthetic surfactants and alkyl ether sulphonates combined with water and air.

At least one of the first and second covering layers usually comprises a glass fibre-based sheeting. Preferably both first and second covering layers comprise such glass fibre-based sheeting, which may be similar or different.

“Glass fibre-based” refers to a sheeting at least partially made of a material comprising very thin strands of glass, or glass fibres. According to the invention, the glass fibre-based sheeting can be a scrim, a mat, a fabric, or combinations thereof. A scrim is made of connected glass fibres forming a grid profile. Scrims are usually loosely woven fabrics having large mesh openings, typically from 1 to 20 mm, preferably from 2 to 10 mm. During the manufacturing of the cement board, the cementitious slurry can easily pass through the mesh openings defined in this grid profile. The resulting mechanical interaction between the cementitious slurry and the mesh openings increases the strength of the cement board once it has been cured. A mat is a non-woven web of glass fibres, while a fabric is a densely woven web of glass fibres, in particular compared to scrims. In some embodiments, the first and/or second covering layers may comprise a combination of a scrim with a mat or a fabric.

The glass-fibre-based sheeting may be fully or partially embedded in a cementitious matrix. The expression “partially embedded” refers to a sheeting where a cementitious matrix (generally from the core of the board) does not penetrate through the full depth of the sheeting, thus resulting in the adhesion of the sheeting to the core of the board. In such a case, the sheeting remains visible on the surface on the board. The expression “fully embedded” refers to a cementitious matrix penetrating completely through the sheeting resulting in a sheeting covered on both side by a cementitious matrix. Such embodiment may result either from the full penetration of the cementitious slurry forming the core through the sheeting during the manufacturing process, or from a pre-coated or pre-impregnated sheeting with a cementitious slurry, which may be identical or different from the slurry forming the core of the board. In some preferred embodiments, the cementitious matrix in which the glass fibre-based sheeting is embedded results from the curing of an aqueous cementitious composition comprising a reactive binder mixture having the same composition as the reactive binder mixture of the core.

In some embodiments, the glass fibre-based sheeting is coated with a resin material on one or both of its sides. The resin material can cover either only one side of the glass fibre-based sheeting or both of its sides, such resin material having waterproof properties.

In particular embodiments, the glass fibre-based sheeting does not have alkali protection. Compared to conventional cement boards, the aqueous cementitious composition according to the invention has a lower pH and therefore the glass fibre-based sheeting requires a lower degree of alkali protection or even no alkali protection. Cheaper low-grade alkali-resistant fibre-based sheeting, or even alkali protection-free glass fibre-based sheeting can thus be used in the board according to the invention without impairing long term mechanical performances.

The process for manufacturing the cement board according to the invention comprises a step of mixing a cementitious slurry, a step of pouring this cementitious slurry onto a conveyor, in which the first covering layer carried by the conveyor is covered with the cementitious slurry, a step of extruding the first covering layer covered in cementitious slurry, a step of cutting it and a curing step.

In some embodiments, before the step of extruding, the second covering layer is put on top of the cementitious slurry covering the first covering layer. Both the first covering layer and the second covering layer are then extruded, cut and cured.

In some embodiments, before being put on top of the cementitious slurry covering the first covering layer, the second covering layer is covered with cementitious slurry. The second covering layer can be put on top of the cementitious slurry covering the first layer either with its face covered in cementitious slurry facing the cementitious slurry of the first covering layer, or with its face covered in cementitious slurry opposite to the cementitious slurry if the first covering layer.

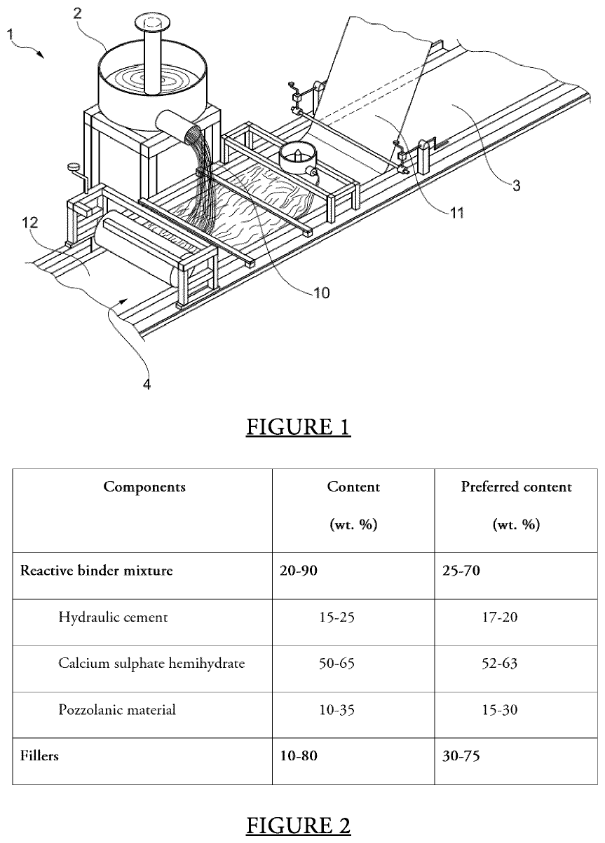

FIG. 1 is a schematic view of a cement board manufacturing process;

FIG. 2 is a table of the components used to manufacture a cement board according to the invention;

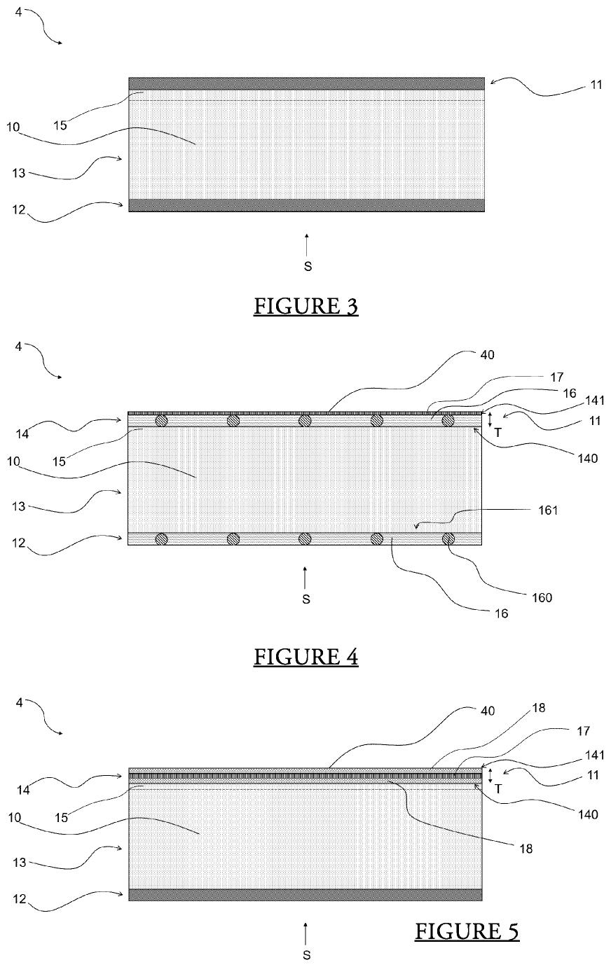

FIG. 3 is a cross-section view of a cement board according to the invention;

FIG. 4 is a cross-section view of the cement board according to a specific embodiment of the invention, with a partially embedded sheeting;

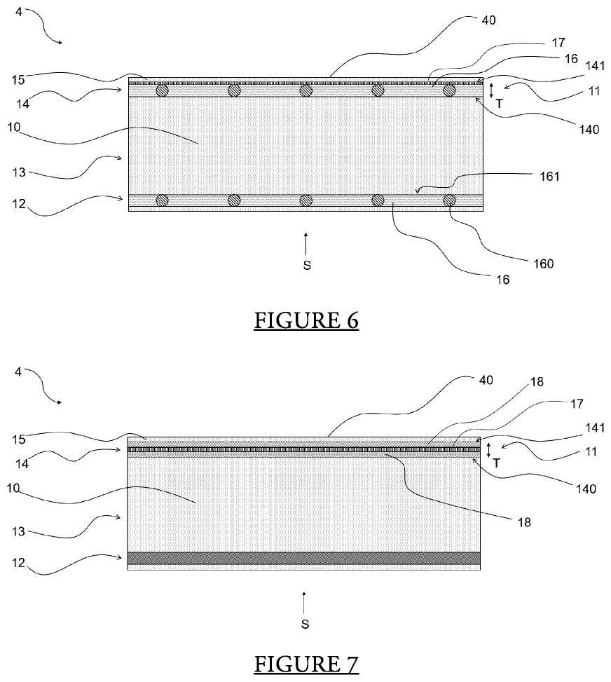

FIG. 5 is a cross-section view of the cement board according to another embodiment of the invention, with a partially embedded sheeting;

FIG. 6 is a cross-section view of the cement board according to the embodiment of FIG. 4, the sheeting being fully embedded;

FIG. 7 is a cross-section view of the cement board according to the embodiment of FIG. 5, the sheeting being fully embedded.

The present invention will now be described more fully hereinafter with reference to the accompanying drawings, in which some, but not all embodiments of the invention are shown. Indeed, the invention may be embodied in many different forms and should not be construed as limited to the embodiments set forth herein; on the contrary, these embodiments are provided so that this disclosure will satisfy applicable legal requirements.

Like numbers refer to like elements throughout drawings.

As shown in FIG. 1, the cement board manufacturing process 1 which is used to manufacture cement boards 4 according to the invention is a continuous process. Such manufacturing process comprises at least a tank 2, in which components for a cementitious slurry 10 are continuously mixed. This cementitious slurry 10 is an aqueous cementitious composition whose components are described hereinafter. The cementitious slurry 10 is poured on a conveyor 3, this conveyor 3 carrying a first covering layer 11. This first covering layer 11 is thus covered with the cementitious slurry 10, the latter forming a lightweight core of the cement boards 4. In some embodiments, the conveyor 3 comprises vibrating components which help spread out the cementitious slurry 10 with its vibrations. The cement boards 4 may also comprise a second covering layer 12, which will be described in relation to FIGS. 3 to 7. Once the cementitious slurry 10 has been poured on the first covering layer 11, they go through an extruder and a cutting station, not shown on FIG. 1, where they are cut into cement boards 4 of desired dimensions. The cement boards 4 can then be stored for a curing process.

As shown in the table of FIG. 2, the components mixed in the tank 2 are, according to the invention, a reactive binder mixture comprising 15 to 25 wt. % of hydraulic cement, 50 to 65 wt. % of calcium sulphate hemihydrate and 10 to 35 wt. % of pozzolanic material, as well as fillers. The reactive binder mixture as a whole makes up 20 to 90 wt. % of the components of the aqueous cementitious composition while the fillers make up the remaining 10 to 80 wt. %. These percentages are based on the solid weight ratio between the component and (wt.) the total dry matter. In some embodiments, the percentages of each component are complementary, meaning if there is 15 wt. % of hydraulic cement and 50 wt. % of calcium sulphate hemihydrate, then there must be 35 wt. % of pozzolanic material, as the total of the percentages must be equal to 100. Another example of a composition covered by the invention would be to have 20 wt. % of hydraulic cement, 60 wt. % of calcium sulphate hemihydrate and 20 wt. % of pozzolanic material.

According to a preferred embodiment of the invention, the reactive binder mixture comprises 17 to 20 wt. % hydraulic cement, 52 to 63 wt. % calcium sulphate hemihydrate, and 15 to 30 wt. % pozzolanic material. According to an embodiment, the aqueous cementitious composition comprises 25 to 70 wt. %, preferably 30 to 50 wt. %, of the reactive binder mixture and 30 to 75 wt. %, preferably 50 to 70 wt. %, of fillers, as a complement of the aqueous cementitious composition.

The pozzolanic material may be selected from silica fumes, fly ash, metakaolin, or mixtures thereof, whereas the fillers can be chosen from aggregates such as sand or calcium carbonate, lightweight fillers such as expanded clay or hydrophobic expanded perlite, and fibres such as glass fibres, synthetic fibres or natural fibres. These fillers are effectively inert materials, which do not significantly react with the reactive binder mixture. The aqueous cementitious composition may also comprise additives or admixtures, e.g., retarders, accelerators, plasticisers or foaming agents. Such additives can be used to alter or enhance the properties of the reactive binder mixture and to improve the quality of the cement board 4.

Preferably, the weight ratio of the calcium sulphate hemihydrate compared to the pozzolanic material is less than 2.5. Similarly, the weight ratio of the hydraulic cement compared to the pozzolanic material is preferably less than 2.

FIGS. 3 to 7 illustrate cross-section views of different embodiments of a cement board 4 according to the invention. The cement board 4 comprises a lightweight core 13 made of cementitious slurry 10 of the aforementioned composition, as well as a first covering layer 11 and a second covering layer 12. The lightweight core 13 lies between these covering layers 11 and 12. According to the invention, at least of one of the first covering layer 11 and second covering layer 12 comprises a glass fibre-based sheeting 14. This sheeting 14 can either be partially embedded in a cementitious matrix 15, as shown in FIGS. 3 to 5, or fully embedded in the cementitious matrix 15, as in FIGS. 6 and 7. The cementitious matrix 15 is thus the part of the cement board 4 in which the glass fibre-based sheeting is embedded. This cementitious matrix 15 can be made of a reactive binder mixture having the same composition as the reactive binder mixture of the lightweight core 13 described hereinbefore, or it can be made of a reactive binder mixture having a different composition. In the embodiments illustrated on the figures, the cementitious matrix 15 is represented as having the same composition as reactive binder mixture of the lightweight core 13.

According to an embodiment, the glass fibre-based sheeting 14 does not need to have a strong alkali protection, as the composition of the lightweight core 13 has a low pH which has a positive impact on the dissolution of the sheeting 14.

On the cross-sections of FIGS. 4 and 6, the cement board 4 is represented with a first covering layer 11 comprising a sheeting 14 comprising both a scrim 16 and a mat 17, and a second covering layer 12 comprising only a scrim 16. These figures illustrate a possible embodiment of the cement board 4, but the invention also intends to cover embodiments in which both the first and the second covering layers 11 and 12 comprise both a scrim 16 and a mat 17, in which both the first and the second covering layers 11 and 12 comprise only a scrim 16, and in which the first covering layer 11 comprises a scrim 16 and the second covering layer 12 comprises both a scrim 16 and a mat 17.

The shape of the sheeting 14 follows the surface 40 of the cement board 4. The scrim 16 being made of a woven grid, sections 160 of this grid are visible. The grid extends both in a longitudinal direction and in a transverse direction, these longitudinal and transverse directions being the directions in which the cement board 4 mainly extends. The grid defines openings 161 in the scrim into which the cementitious matrix 15 can flow, thus creating a mechanical interaction with the scrim 16. These openings 161 in the scrim 16 must be sufficiently large so that the cementitious matrix 15 can penetrate inside the scrim 16. The mat 17 is placed over the scrim 16 according to a stacking direction S of the lightweight core 13 and the first and second covering layers 11 and 12. The mat 17 thus sits between the scrim 16 and the surface 40 of the cement board 4. The scrim 16 is here made of glass fibres, but it could also be made of a metallic material.

On the cross-sections of FIGS. 5 and 7, which are other embodiments of the invention, the cement board 4 is represented with a first covering layer 11 comprising a mat 17, for example of glass fibre, this mat being coated with a resin material 18. The resin material 18 can be a thermoplastic resin, e.g., polyethylene terephthalate (PET). This resin material 18 covers both sides of the mat 17, these sides being defined according to the stacking direction S of the lightweight core 13 and the first and second covering layers 11 and 12. As an alternative not shown here, the resin material 18 can cover only one of the two sides of the mat 17.

The resin material 18 makes the cement board 4 waterproof, preventing water from reaching the lightweight core 13. This lightweight core 13 is thus protected from humidity, which is advantageous for use in highly humid environments, such as swimming pools and humid climates.

As explained above, the glass fibre-based sheeting 14 can either be partially or fully embedded in the cementitious matrix 15.

When the glass fibre-based sheeting 14 is partially embedded in the cementitious matrix 15, as is the case in FIGS. 3, 4 and 5, the sheeting 14 is visible on the surface 40 on the cement board 4 as it sits at this surface 40 of the cement board 4. In this case, the cementitious matrix 15 seeps into the sheeting 14 from a first of its ends 140 but does not go through to a second of its ends 141. In other words, the cementitious matrix 15 penetrates the sheeting 14 but does not go fully through its thickness T, such thickness T being defined by the distance from the first end 140 to the second end 141 of the sheeting 14, measured along the stacking direction S of the lightweight core 13.

On the other hand, when the glass fibre-based sheeting 14 is fully embedded in the cementitious matrix 15, as is the case in FIGS. 6 and 7, this cementitious matrix 15 penetrates it from its first end 140 to its second end 141, meaning that the cementitious matrix 15 goes through the sheeting 14. As a result, the glass fibre-based sheeting 14 is does not form the surface 40 of the cement board 4 and is fully immersed inside the cementitious matrix 15.

The glass fibre-based sheeting 14 can be fully embedded during the cement board manufacturing process 1 explained relative to FIG. 1, and in this case the composition of the cementitious matrix 15 is identical to the composition of the cementitious slurry 10 of the lightweight core 13. Alternatively, the glass fibre-based sheeting 14 can be coated or impregnated beforehand with a cementitious slurry. This cementitious slurry may be identical or different from the cementitious slurry 10 forming the lightweight core 13 of the cement board 4.

Any modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A cement board comprising a lightweight core between a first covering layer and a second covering layer, wherein the lightweight core results from the curing of an aqueous cementitious composition comprising, based on the total dry matter, 20 to 90 wt % of a reactive binder mixture and 10 to 80 wt % of fillers, wherein said reactive binder mixture comprises, based on the total dry matter of the reactive binder mixture:
15 to 25 wt % hydraulic cement,
50 to 65 wt % calcium sulphate hemihydrate, and
10 to 35 wt % pozzolanic material; and
at least one of the first and second covering layers (11, 12) comprises a glass fibre-based sheeting, said sheeting being fully or partially embedded in a cementitious matrix.

2. The cement board according to claim 1, wherein a weight ratio of the calcium sulphate hemihydrate to pozzolanic material is less than 2.5.

3. The cement board according to claim 1, wherein a weight ratio of the hydraulic cement to pozzolanic material is less than 2.

4. The cement board according to claim 1, wherein the pozzolanic material is selected from silica fumes, fly ash, metakaolin, or mixtures thereof.

5. The cement board according to claim 1, wherein the reactive binder mixture comprises, based on the total dry matter of the reactive binder mixture:
17 to 20 wt % hydraulic cement,
52 to 63 wt % calcium sulphate hemihydrate, and
15 to 30 wt % pozzolanic material.

6. The cement board according to claim 1, wherein the aqueous cementitious composition comprises 25 to 70 wt. % of the reactive binder mixture and 30 to 75 wt. % of fillers.

7. The cement board according to claim 1, wherein the fillers are selected from aggregates, lightweight fillers, and fibres.

8. The cement board according to claim 1, wherein the cementitious matrix in which the glass fibre-based sheeting is embedded results from the curing of an aqueous cementitious composition comprising a reactive binder mixture having the same composition as the reactive binder mixture of the core.

9. The cement board according to claim 1, wherein the glass fibre-based sheeting is coated with a resin material on one or both of its sides.

10. A process for manufacturing the cement board according to claim 1, comprising mixing a cementitious slurry, pouring the cementitious slurry onto a conveyor, in which a first covering layer carried by the conveyor is covered with the cementitious slurry, the latter forming a lightweight core of the cement board, extruding and cutting the first covering layer covered in cementitious slurry, into a cement board of the desired dimension and curing the lightweight core of the cement board.

11. A process for manufacturing the cement board according to claim 10, wherein before the extruding, a second covering layer (12) is put on top of the cementitious slurry covering the first covering layer.

12. A process for manufacturing the cement board according to claim 11, wherein before being put on top of the cementitious slurry covering the first covering layer, the second covering layer is covered with cementitious slurry.

13. The cement board according to claim 1, wherein the glass fibre-based sheeting is a scrim, a mat or a fabric.

14. The cement board according to claim 6, wherein the aqueous cementitious composition comprises 30 to 50 wt. % of the reactive binder mixture and 50 to 70 wt. % of fillers.

15. The cement board according to claim 7, wherein the aggregates include sand or calcium carbonate.

16. The cement board according to claim 7, wherein the lightweight fillers include expanded clay or hydrophobic expanded perlite.

17. The cement board according to claim 7, wherein the fibres include glass fibres, synthetic fibres or natural fibres.
